(19) United States
(12) Patent Application Publication
(10) Pub. No.: US 2020/0277162 A1
(43) Pub. Date: Sep. 3, 2020

(54) METHOD FOR ELECTRICAL ATTACHMENT OF A CONNECTING ELEMENT TO A BELT FOR AN ELEVATOR SYSTEM, AND CORRESPONDING BELT ASSEMBLY

(71) Applicant: Inventio AG, Hergiswil (CH)

(72) Inventor: Yves Larboulette, Rupperswil (CH)

(21) Appl. No.: 16/646,731

(22) PCT Filed: Sep. 7, 2018
(86) PCT No.: PCT/EP2018/074113

§ 371 Date: Mar. 12, 2020

(30) Foreign Application Priority Data
Sep. 15, 2017 (EP) 17191369.2

(51) Int. Cl. B66B 7/12; B66B 19/00; B66B 7/06; H01R 4/2406; H01R 43/01

(52) U.S. Cl. CPC B66B 7/1223; B66B 19/00; H01R 43/01; H01R 4/2406; B66B 7/062

(57) ABSTRACT

A method for establishing an electrical connection to an elevator system load-bearing belt uses a connecting element. The connecting element has a plurality of electrically conductive contact pins arranged at a distance from one another in an arrangement direction, and at least one of the contact pins is electrically connected to an electric line extending from the connecting element. The belt has a plurality of electrically conductive cables, embedded in an electrically insulating matrix material, and arranged at a distance from one another in the arrangement direction. The steps of the method include pressing the spacer pins in between adjacent cables in the belt in order to adjust the cables to a target position, and then pressing the contact pins of the connecting element into the cables in the belt. The spacer pins can be part of the connecting element or provided on a press-in tool to be used separately.

### FIELD

The present invention relates to a method for establishing an electrical connection between a connecting element and a load-bearing belt for an elevator system. The invention further relates to a belt arrangement for an elevator system.

### BACKGROUND

In modern elevator systems, elevator cars are moved vertically through an elevator shaft by means of belts driven by a drive unit. The belts generally comprise a plurality of cables, which are sometimes also called wires or cords, and which mainly effect a load-bearing capacity of the belt. Metal wires, metal wire meshes, or metal strands are mostly used as cables. The cables are embedded in a matrix material in order to effect protection of the cables, for example, against abrasion and/or corrosion, and to be able to increase friction between the belt and, for example, a traction sheave of the drive unit. The matrix material can be a flexible material, for example, a plastic material, particularly a polymer or an elastomer.

Since the belts hold the elevator car and thus play an important role in ensuring the safety of the elevator system, their integrity must always be ensured. Methods have been developed to monitor the integrity of belts of an elevator system by electrically contacting the electrically conductive cables integrated in the belts from the outside. Electrical properties of the cables thus contacted can then be monitored, for example, in order to be able to determine changes in the belt, particularly with regard to its load-bearing capacity, due to changes in these electrical properties occurring over time. Various embodiments of such an approach for monitoring the integrity of belts in an elevator system are described, for example, in WO 2017/021263 A1.

In order to be able to suitably contact the cables within the belt electrically, different methods, connecting elements and/or tools have been developed.

For example, it can be provided that two adjacent cables in the belt are electrically contacted simultaneously by means of a single connecting pin in that the connecting pin is selected sufficiently wide and pressed between the two cables to mechanically and electrically contact the respective outer surfaces of each of the two cables. However, such a contacting method can lead to deficiencies with regard to the contacting of individual wires. For example, individual cables may not bear correctly against one of the contact pins, so that no electrical contact or a high electrical contact resistance is established.

Alternatively, methods have been developed, in which at least one sharpened connecting pin is pressed directly into one of the cables of a belt in order to contact said cable electrically. If the cable is penetrated sufficiently, it can result in a permanent electrical contact with low contact resistance.

However, it has been observed that problems can arise in the last-mentioned method in that, during the establishment of the electrical connection between the belt and the connecting element, a sufficient and/or reliable electrical contacting of the cables in the belt cannot be achieved in all cases or at least not with simple means.

Among others, there can be a need for a method, by means of which an electrical contact between contact pins of a connecting element and cables in a belt of an elevator system can be established in a reliable and/or simple manner. Furthermore, there can be a need for a belt arrangement for an elevator system, in which such an electrical contact is reliably established.

### SUMMARY

Such a need can be met by the method and/or the belt arrangement according to advantageous embodiments defined in the following description.

According to a first aspect of the invention, a method for establishing an electrical connection between a connecting element and a load-bearing belt for an elevator system is proposed. For such purpose, the connecting element has a plurality of electrically conductive contact pins, which are arranged at a distance from one another in an arrangement direction, and at least one of said contact pins is electrically connected to an electric line extending out of the connecting element. The belt has a plurality of electrically conductive cables which are embedded in an electrically insulating matrix material and which are arranged at a distance from one another in the arrangement direction. The proposed method has at least the following method steps: The contact pins of the connecting element are pressed into the cables in the belt; spacer pins are additionally pressed between adjacent cables in the belt.

According to a second aspect of the invention, a belt arrangement for an elevator system with a load-bearing belt and a connecting element contacting the belt is proposed. For such purpose, the connecting element once again has a plurality of electrically conductive contact pins, which are arranged at a distance from one another in an arrangement direction, and at least one of said contact pins is electrically connected to an electric line extending out of the connecting element. The belt has a plurality of electrically conductive cables which are embedded in an electrically insulating matrix material and which are arranged at a distance from one another in the arrangement direction. The contact pins of the connecting element are pressed into the cables of the belt. Between adjacent cables of the belt, indentations are additionally pressed into the matrix material of the belt which extend between the adjacent cables.

According to a third aspect of the invention, a connecting element for electrically contacting cables within a belt for an elevator system is proposed, wherein the connecting element has a plurality of electrically conductive contact pins which protrude from a frame of the connecting element and are arranged at a distance from one another in an arrangement direction, and electrically insulating spacer pins arranged between adjacent contact pins in the arrangement direction.

Possible features and advantages of embodiments of the invention can be considered, among others and without delimiting the invention, to be based on the concepts and findings described below.

As initially explained, it has been observed that sometimes inadequate electrical connections were established when the attempt was made to contact cables of a belt by directly pressing contact pins into the cables.

It has now been found that such deficient electrical contacts can be attributed to the fact that the contact pins of the connecting element do not or at least insufficiently accurately strike the cables in the belt when the electrical connection is established. Among others, this has been found as a result of the fact that the cables in the belt are not always arranged at the intended positions, for example, due to manufacturing tolerances. Instead, cables can run slightly offset from the intended positions. Accordingly, the attempt to press at least one contact pin into each of these cables can result in the fact that the contact pin does not strike the respective cable in the center, as desired, but brushes such cable only at the edge or, in the worst case, does not touch it at all. This can be the case particularly because manufacturing tolerances can often be of the same order of magnitude as the diameters of the cables when the cables are positioned in the matrix material of a belt. For example, in case of cable diameters of approximately 1 mm, manufacturing tolerances during the positioning of such cables within the matrix material of the belt can sometimes be up to 0.5 mm.

In order to overcome the described problem of the varying deviations of the position of cables within the belt from desired target positions and the resulting deficient contacting of the cables by pressed-in contact pins, it is proposed that, during the attachment of the connecting element to the belt, so-called spacer pins are pressed into the belt in addition to the contact pins. While the contact pins of the connecting element are pressed as directly as possible into the cables of the belt, the spacer pins are supposed to be pressed into the belt between two adjacent cables.

The spacer pins are supposed to move the cables running in the belt to a desired target position, and so the contact pins can then be accurately pressed into the cable and thus contact them reliably. The spacer pins thus form a kind of template which can be pressed into the belt, thereby moving the cables, which are possibly not arranged at desired positions in the belt, to the desired target positions.

In the following, possible embodiments of components of both the belt and the connecting element and perhaps of tools to be possibly used for establishing the electrical connection between the connecting element and the belt according to the invention, shall be described.

The belts can be conventional belts as have been used in elevator systems for holding and moving elevator cars for a long time. A belt can have a length from several meters to several hundred meters, a width of a few centimeters, and a height of a few millimeters. As a rule, electrically conductive cables run in the belt over the entire length of the belt, usually in the form of metal wires, particularly steel wires or strands. The cables typically have diameters in the range from 0.5 mm to 5 mm, preferably 1 mm to 2 mm. The cables are embedded in a matrix material which gives the belt its outer shape. Particularly polymers or other plastics are used as the matrix material. The cables generally run parallel to one another. A distance between adjacent cables is typically similar to the diameter of the cables. For example, such a distance can be in the range from 0.5 mm to 5 mm, preferably 1 mm to 2 mm. The lateral distances between adjacent cables can be the same for all cables of a belt, i.e., the cables can be arranged equidistantly in the belt along the arrangement direction, i.e., transversely to a longitudinal extension direction of the cables. Matrix material arranged between adjacent cables provides an electrical insulation between the cables. The cables can be arranged slightly below a surface of the matrix material of the belt, for example, at a depth between 0.2 mm and 2 mm, and so the overlapping matrix material protects the cables from chemical and/or mechanical attacks. The belt can be profiled on at least one surface, which comes into contact as a traction surface, for example, with a traction sheave of the driving engine, for example, with grooves running in the longitudinal direction of the belt.

The connecting element can have a housing or a frame, and from the surface of such a housing or frame which faces the belt, the contact pins protrude, preferably in a direction transversely, particularly perpendicularly, to said surface of the housing or the frame and thus also transversely or perpendicularly to the arrangement direction, along which the contact pins are arranged next to and at a distance from one another. The housing or the frame of the connecting element can be dimensioned such that they can bear against at least one surface of the belt to be contacted. Alternatively, the housing or the frame can be designed such that they enclose the belt to be contacted on both sides or on all sides. The housing or the frame can consist of an electrically non-conductive material, particularly plastic.

The contact pins of the connecting element are electrically conductive. Particularly one surface of the contact pins consists of an electrically conductive material. For example, the contact pins can be made of metal, particularly steel or stainless steel, or be coated with such a metal.

The contact pins are preferably arranged parallel to one another. They have at least a length which is slightly greater than a depth, at which the cables are embedded in the belt at a distance from a surface of the belt. In such case, said depth corresponds to a thickness of a layer of matrix material which covers the cables toward the outside. The contact pins should particularly be at least 10%, preferably at least 20%, more preferably at least 50%, longer than said depth. Particularly when said depth is, for example, 0.5 mm, the contact pins can, for example, have a length of at least 0.6 mm, but more preferably of at least 1 mm or more.

The contact pins can have a round cross-section, i.e., have a diameter. Alternatively, the contact pins can have any other cross-sectional geometry, for example, a rectangular cross-section, while having a width measured in the arrangement direction.

The contact pins can have a diameter or a width which at least roughly corresponds to the diameter or the width of the cable to be contacted by said contact pins, for example, a diameter or a width in the range from 10% to 200%, preferably in the range from 30% to 130% of the diameter or width of the cables to be contacted. For example, a diameter or a width of the contact pins can lie in the range from 0.3 mm to 3 mm, preferably in the range from 0.5 mm to 1.5 mm.

A lateral distance (measured along the arrangement direction) between adjacent contact pins can be equal to or essentially equal to a lateral distance between adjacent cables of the belt to be contacted.

At their self-supporting end, i.e., at the end which faces the belt when the electrical connection is established, the elongated contact pins can be designed to be pointed, i.e., tapered. Due to such a pointed design, the pins can be pressed relatively easily, i.e., with technically easily generated forces, into the matrix material of the belt and subsequently into the cables embedded therein. For such purpose, a curve radius of the tip can be significantly smaller than the diameter or the width of the contact pin. For example, the curve radius of the tip can be less than 50%, preferably less than 20%, 10%, or even 5%, of the diameter or the width of the contact pin.

At least one of the contact pins of the connecting element is supposed to be able to apply an electrical voltage to at least one of the cables in the contacted belt via the connecting element. For this purpose, at least this contact pin is electrically connected to an electric line extending out of the connecting element. Preferably, a plurality of the contact pins of the connecting element is electrically connected to one of a plurality of electric lines extending out of the connecting element or to the same electric line extending out of the connecting element. Via the electric lines extending out of the connecting element, electrical voltages can be applied in the desired manner to the cables of the belt which are contacted by the contact pins connected to said electric lines. Other contact pins cannot be connected to such an electric line extending out of the connecting element, but they can instead be connected to further contact pins of the connecting element in order to be able to short-circuit, for example, two or more cables of the belt.

The spacer pins are preferably designed such that they can be pressed into the belt and thereby penetrate the matrix material of the belt. With regard to their dimensions and geometry, the spacer pins are designed such that they can be pressed into areas between two adjacent cables within the belt and, if necessary, press the adjacent cables laterally toward their target positions. The arrival of the spacer pins can thus effect an adjustment of the cables in the belt at desired target positions, and so the contact pins can then be pressed in a simple, perfectly fitting and/or reliable manner into the thus adjusted cables. The spacer pins can have the same or similar dimensions as the contact pins and/or be arranged at similar lateral distances from one another. Particularly a length, a diameter, or a width and/or lateral spaces in between in case of the spacer pins can be equal to or, for example, between 5% and 50% greater or smaller than corresponding properties in the case of the contact pins. The spacer pins can be aligned parallel to one another and/or parallel to the contact pins.

According to one embodiment, the spacer pins are pressed between the cables before the contact pins are pressed into the cables.

In other words, in the method proposed herein, the spacer pins are preferably pressed between the cables of the belt in order to press the cables toward their target positions before the contact pins are pressed into the cables. Such a successive pressing-in of the spacer pins followed by the contact pins can be realized in various ways.

For example, the spacer pins can initially be pressed into the belt to a depth, where they lie between adjacent cables, before the contact pins are subsequently pressed into the belt. In this case, the spacer pins can, for example, be part of a tool to be provided separately from the connecting element and thus be pressed into the belt before the connecting element is pressed against the belt.

Alternatively, the spacer pins can be pressed into the belt virtually simultaneously with the contact pins, wherein a geometry of the spacer pins can be selected such that they reach the area between adjacent cables before the contact pins have been pressed to a depth into the matrix material of the belt, at which they reach the surface of the cables. For this purpose, for example, the spacer pins can be significantly longer or protrude much further toward the belt than the contact pins. In the case of the spacer pins, a self-supporting end can, for example, protrude at least 0.5 mm, preferably at least 1 mm or at least 2 mm, further in the direction of the belt than in the case of the contact pins.

According to one embodiment, the spacer pins have tips at their self-supporting end that have a greater radius of curvature than tips on the self-supporting ends of the contact pins.

Similar to the contact pins, the spacer pins should be sharpened at their self-supporting end, so that they can be pressed into the matrix material of the belt without difficulty, i.e., with acceptable force. However, the spacer pins do not need and are not supposed to be pressed into the significantly harder cables; instead, when pressed into the belt, they are supposed to slide with their outer edge along these cables in order to be able to move them to their target position. Accordingly, a radius of curvature at the tips of the spacer pins should be significantly greater, i.e., for example, more than 20%, more than 50%, more than 100% or even more than 200% greater than at the tips of the contact pins.

According to one embodiment, the spacer pins can particularly have tips at their self-supporting end which have a radius of curvature that is between 0.3 and 3 times greater than the width of the spacer pins.

In other words, the spacer pins, when compared to the contact pins, can be provided with a relatively blunt tip, whose radius of curvature is between one-third and three times the width, i.e., the dimension of a spacer pin measured in the arrangement direction defined above. In this case, the width of the spacer pins is measured at its widest point, i.e., at a point on the other side of its tapering tip. With such a blunt tip, spacer pins can still be pressed into the relatively soft matrix material, but the risk that a spacer pin is pressed into a significantly harder cable is low. Instead, the spacer pin with its rounded tip will press the cable sideways to its target position when it encounters said cable.

According to one embodiment, the spacer pins have a width which is equal to or smaller than distances between adjacent cables in the belt.

In other words, the width of the spacer pins is supposed to be dimensioned such that a spacer pin fits precisely or with a slight lateral play between two adjacent cables of the belt. As a result, the spacer pin, when pressed between the adjacent cables of the belt, can exert lateral pressure on possibly incorrectly positioned cables in order to press them toward their target position.

According to one embodiment, the spacer pins consist of an electrically insulating material.

In other words, a spacer pin, unlike the contact pins which are supposed to effect an electrical contact toward one of the cables, can consist of an electrically non-conductive material. Accordingly, the spacer pin can be in mechanical contact with one or two adjacent cables in the belt, but no electrical contact with or between these cables is established. Since the spacer pin is subjected to high mechanical forces when pressed into the belt, the material of the spacer pin should be suitably selected, so that it will not be damaged when pressed in.

Alternatively or additionally to the aforementioned embodiment, the spacer pins can be coated with an electrically insulating material.

In other words, a main part of a spacer pin, which consists of any, i.e., electrically conductive or electrically insulating, material, can be coated with an electrically non-conductive material. In such case, the main part can consist of a mechanically resistant material, such as metal, particularly steel, which can be electrically conductive. In order to prevent electrical contact with the spacer pin mechanically contacted by a spacer pin, an insulating layer of electrically insulating material can be applied to the surface of the main part. In this case, the insulating layer can be very thin, i.e., for example, have a thickness in the range between 5 μm and 500 μm.

According to one embodiment, the electrically insulating material, of which a spacer pin consists or with which the spacer pin is coated, can be a plastic or a ceramic.

If the spacer pin has a mechanically stable main part and is coated only on its surface with the electrically insulating material, the material only needs to have sufficiently electrically insulating properties and otherwise, for example, only be sufficiently resistant to abrasion, so as not to be abraded when the spacer pin is pressed into the belt. In this case, almost all plastics or ceramics can be used to form the insulation layer.

In the event that the entire spacer pin is supposed to consist of the electrically insulating material, a sufficient strength of the spacer pin should be ensured. Accordingly, for example, sufficiently hard and/or break-proof materials should be used. For this purpose, for example, plastics such as cured epoxy resin, COC (cyclo-olefin copolymers), PA (polyamide), PBT (polybutylene terephthalate), PMMA (polymethyl methacrylate), PP (polypropylene), or similar plastics come into consideration. Various ceramic materials can be used and provide the required electrical insulation as well as mechanical strength.

According to one embodiment, the spacer pins can be part of the connecting element.

In other words, the spacer pins as well as the contact pins can be formed on the connecting element and protrude, for example, from a surface of a frame or housing of the connecting element which faces the belt. In such case, at least one spacer pin each can be provided particularly between two contact pins adjacent in the arrangement direction.

The connecting element equipped with both contact pins and spacer pins can then be placed, with the surface from which the contact pins and spacer pins protrude, on a surface of the belt and subsequently pressed into such surface to establish the desired electrical connection with the cables in the belt. In this case, the spacer pins first press between adjacent cables and align them before the cables are then penetrated by the contact pins and thus electrically contacted.

In such an embodiment, the spacer pins together with the remainder of the connecting element remain permanently on the contacted belt. In this case, the spacer pins extend into the indentations which are formed during the press-in process and extend between the adjacent cables in the matrix material of the belt. One spacer pin is pressed into each of the indentations. As a result, these indentations are sealed toward the outside by the spacer pins received therein, and so, for example, no moisture can reach the indentations and at worst attack adjacent cables in a corrosive manner.

According to one embodiment, the spacer pins can alternatively be part of a press-in tool.

In other words, the spacer pins do not necessarily have to be part of the connecting element. Instead, the spacer pins can be provided on a press-in tool to be provided separately. While establishing the electrical connection between the connecting element and the belt, said press-in tool can be temporarily pressed into the belt in order to position the cables embedded therein in a desired manner. Due to the pressing-in of the spacer pins, the indentations are formed between adjacent cables in the matrix material of the belt. Once the connecting element has been mounted on the belt and its contact pins have been pressed into the cable of the belt, the press-in tool can be removed, if necessary. In such case, the indentations generated by the spacer pins and extending between the adjacent cables remain in the matrix material of the belt.

According to one embodiment, the matrix material can optionally be sealed in the area of the indentations with a layer covering the indentations.

In such case, the layer used for sealing can cover and seal the indentations such that, for example, moisture penetration through the indentations into the interior of the belt can be prevented. In this way, for example, corrosion on the cables running inside the belt can be prevented. The sealing layer can be thin, for example, in the range from 5 μm to 500 μm and/or should have an elasticity or flexibility suitable for the intended purpose on the belt. For example, the layer can consist of plastic.

It must be noted that some of the possible features and advantages of the invention herein are described with reference to different embodiments of both the method for establishing an electrical connection between a connecting element and a belt, and the belt arrangement to be thus produced or the connecting element to be used for such purpose. A person skilled in the art recognizes that the features can be combined, adapted, transferred, or exchanged in a suitable manner in order to arrive at further embodiments of the invention.

In the following, embodiments of the invention shall be described with reference to the attached drawings, wherein neither the drawings nor the description are to be interpreted as a delimitation of the invention.

### DESCRIPTION OF THE DRAWINGS

FIG. 1 shows a perspective view of a belt for an elevator system as well as a connecting element for establishing an electrical connection and thus forming a belt arrangement according to an embodiment of the present invention.

FIG. 2 shows a sectional view of a belt contacted by contact pins of a connecting element in an ideal case.

FIG. 3 shows a sectional view of a belt contacted by contact pins of a connecting element in a real case.

FIG. 4 shows a sectional view of a belt contacted by contact pins of a connecting element, in which the electrical connection has been established by means of a method according to an embodiment of the present invention, wherein spacer pins form components of the connecting element.

FIG. 5 shows a sectional view of a belt contacted by contact pins of a connecting element, in which the electrical connection has been established by means of a method according to an alternative embodiment of the present invention, wherein spacer pins form components of a press-in tool.

The drawings are merely schematic and not to scale. In the different drawings, the same reference signs denote the same or similarly acting features.

### DETAILED DESCRIPTION

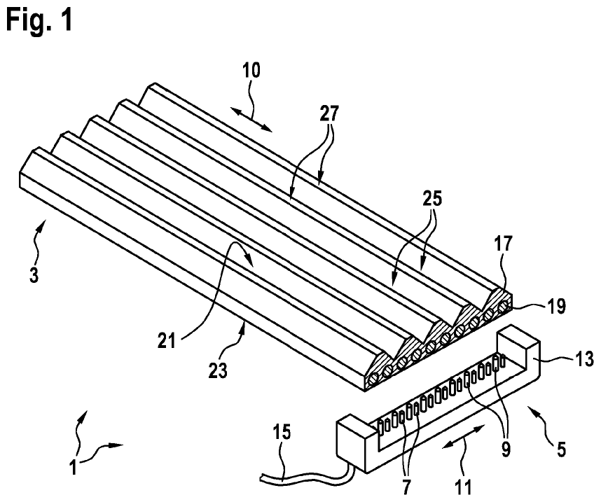

FIG. 1 shows a belt arrangement 1 having a load-bearing belt 3 for an elevator system, and a connecting element 5.

The belt 3 is designed as an elongated belt. An outer geometry of the belt 3 is predetermined by a polymer-type matrix material 17. When in use, the matrix material 17 forms a profiled side 21 on a surface facing the drive disk of the elevator system and a flat side 23 on an opposite surface. On the profiled side 21, grooves 25 running in a longitudinal extension direction 10 of the belt 3 and intermediate ridges 27 are located. The grooves 25 run parallel to one another at a distance of a few millimeters, for example, 5 mm.

A plurality of cables 19 is embedded in the matrix material 17 along the longitudinal extension direction 10 and parallel to one another. In this case, the cables 19 are spaced apart from one another, for example, with lateral distances of approximately 1 to 2 mm, in an arrangement direction 11 which runs parallel to the flat side 23 and perpendicularly to the longitudinal extension direction 10. For that purpose, the cables 19 have a diameter of approximately 1 to 2 mm. The cables 19 typically run at a depth of approximately 0.3 mm to 0.5 mm below the surface of the flat side 23 of the belt 3. Two cables 19 usually run in the area of one of the ridges 27.

The connecting element 5 has a frame 13 or a housing. From this frame 13 or housing, both a plurality of contact pins 7 and a plurality of spacer pins 9 protrude toward the belt 3 from a surface which faces the belt 3. In particular, both the contact pins 7 and the spacer pins 9 run approximately perpendicularly to the surface of the frame 13 which faces the belt 3. In such case, the contact pins 7 and the spacer pins 9 are aligned parallel to one another. Furthermore, the contact pins 7 and the spacer pins 9 are positioned alternately along the arrangement direction 11. In other words, a spacer pin 9 is located between two adjacent contact pins 7, and a contact pin 7 is located between two adjacent spacer pins 9. The spacer pins 9 and the contact pins 7 can, but do not have to, be arranged along a common straight line. For example, the spacer pins 9 can be arranged along a straight line, and the contact pins 7 can be arranged along a further straight line running parallel thereto. Both lines can be parallel to the arrangement direction 11. The contact pins 7 are each spaced laterally apart from one another along the arrangement direction 11. The spacer pins 9 are also laterally spaced apart from one another along the arrangement direction 11. A lateral distance between adjacent contact pins 7 can essentially correspond to a lateral distance between adjacent cables 19 within the belt 3.

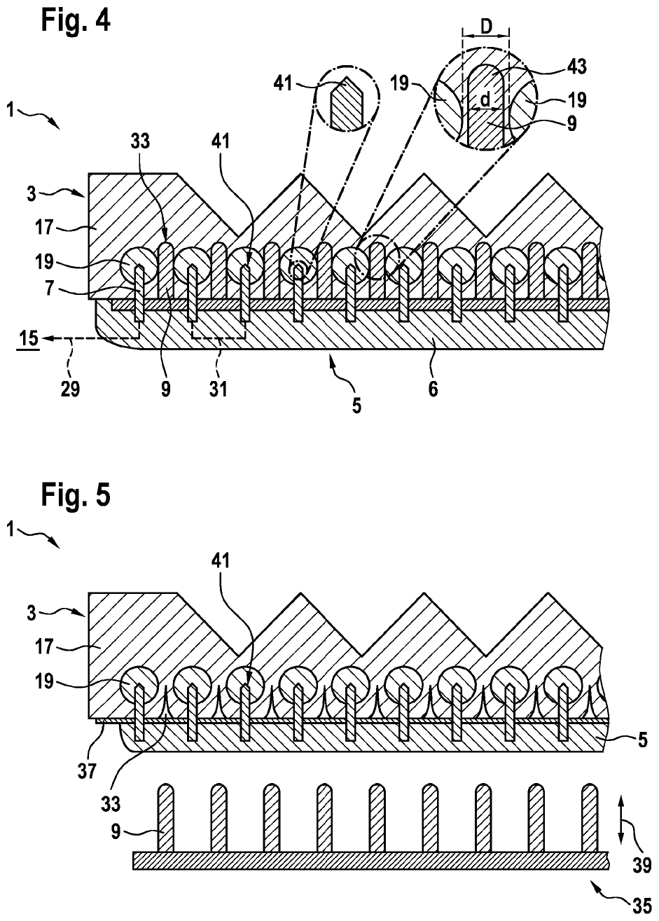

The connecting element 5 is provided to establish an electrical connection between its contact pins 7 and the cables 19 in the belt 3 in order to create, for example, a possibility for electrically connecting the cables 19 to an external measuring or monitoring device by means of the connecting element 5. In such case, the measuring or monitoring device can apply an electrical voltage to one or more electric lines 15 provided on the connecting element 5. These electric lines 15 can be in contact with one or more of the contact pins 7 via one or more connections 29 (see FIG. 4) and can transmit the applied voltage via said contact pins 7 to the cables 19 thus contacted. Other contact pins 7 can be short-circuited or connected in parallel via short-circuit connections 31 (see FIG. 4) with one another or with the connection pins 7 which are connected to the electric line 15. By monitoring the applied voltages or resulting voltages after passing through the cables 19, changes in the electrical properties of the cables 19 can subsequently be detected and conclusions about changes in the mechanical properties of the cables 19 and thus of the entire belt 3 can be drawn.

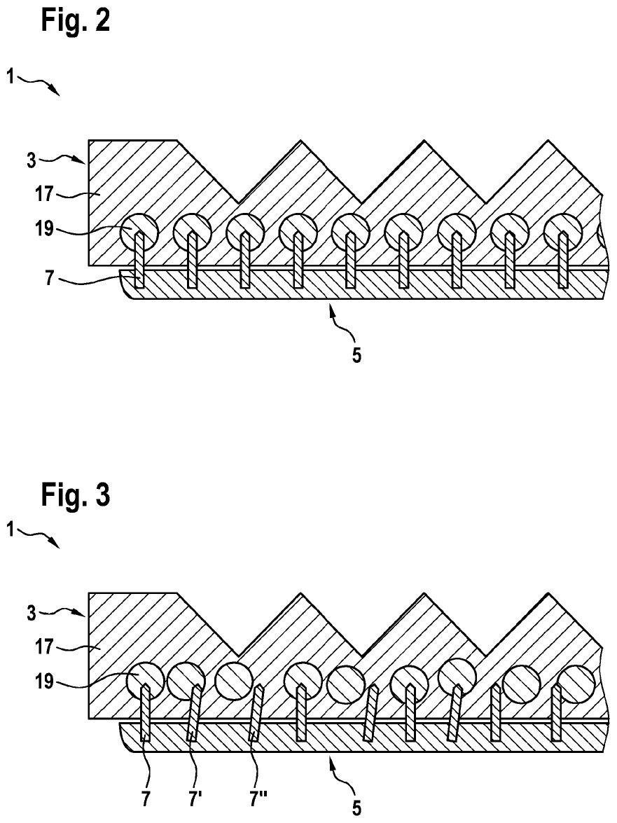

In order to better understand the characteristics of the belt arrangement 1 and the specific connecting element 5 used therein or the way, in which this connecting element 5 is used to establish an electrical connection with the belt 3, the problems that can occur when contacting belts 3 with conventional connecting elements shall be briefly explained with reference to FIGS. 2 and 3.

FIG. 2 shows the ideal case, in which one contact pin 7 of the connecting element 5 centrally penetrates one of the cables 19 embedded in the belt 3. In this case, the cables 19 are arranged equidistantly and exactly at the target position within the matrix material 17, and the contact pins are arranged such that each contact pin can centrally strike a cable assigned to it. In this ideal case, a very good electrical contact between a respective contact pin 7 and the associated cable 19 would be established.

However, as indicated in FIG. 3, in reality, the cables 19 are not evenly arranged within the belt 3, as assumed in the ideal case. Instead, actual positions of the cables 19 deviate from intended equidistant target positions, for example, due to manufacturing tolerances in the production of the belt 3. In real cases, positional deviations can often constitute up to half the diameter of a cable 19. Due to such positional deviations, it is possible that some of the contact pins 7 do not strike the cable 19 to be contacted centrally (contact pin 7′) or, in the worst case, not at all (contact pin 7″), resulting in an unreliable or no electrical contact between the connecting element 5 and the cables 19 concerned.

In order to prevent the described problem, it is therefore proposed that, in addition to the contact pins 7, spacer pins 9 are also pressed into the belt 3 when an electrical connection between a connecting element 5 and a belt 3 is established. In such case, the contact pins 7 are supposed to be pressed into the cable 19 of the belt 3, whereas each spacer pin 9 is supposed to be pressed between adjacent cables 19 in the belt 3. This is shown schematically in FIG. 4. In contrast to the contact pins 7 which consist of an electrically conductive material, the spacer pins 9 are formed from an electrically non-conductive material or are at least coated with such a material. On their self-supporting ends, the contact pins 7 further have sharp tips 41 with a small radius of curvature, whereas the spacer pins 9 have blunt tips 43 with a larger radius of curvature at their self-supporting ends. The spacer pins 9 have a width d which is smaller than or equal to a lateral distance D between adjacent cables 19.

In the example shown in FIGS. 1 and 4, both the contact pins 7 and the spacer pins 9 are designed as components of the connecting element 5. In this case, the spacer pins 9 are slightly longer or protrude further from a main part 6 of the connecting element 5, so that, when pressing the connecting element 5 to the flat side 23 of the belt 3, the spacer pins 9 are pressed first between adjacent cables 19 in the belt 3, forcing said cables 19 to move laterally to their target positions, i.e., adjusting them positionally. Only then have the contact pins 7 penetrated far enough into the matrix material 17, so that they reach the surface of the previously adjusted cables 19 and finally penetrate them with a further pressing-in. The contact pins 7 penetrating the respective cables 19 in this case in a largely centered manner can provide a reliable electrical contacting at low contact resistances. The spacer pins 9, which form part of the connecting element 5, remain in this case in indentations 33 formed by them during the pressing-in process in the matrix material 17 of the belt, thereby sealing the indentations 33, for example, against penetrating water.

Alternatively to the aforementioned design, in which both the spacer pins 9 and the contact pins 7 are components of the connecting element 5 and both types of pins are pressed together into the belt 3, a positional adjustment of the cables 19 in the belt 3 can also be performed with the aid of a separate press-in tool 35, as illustrated in FIG. 5.

In this case, a plurality of spacer pins 9 is provided on the press-in tool 35. With respect to their dimensions and distances, the spacer pins 9 are designed such that they each can be pressed in between adjacent cables 19 in the belt 3 in a press-in direction 39, thus positionally adjusting said cables 19. A connecting element 5 with its protruding contact pins 7 can subsequently be pressed precisely positioned onto the belt 3, so that the contact pins 7 are pressed with their self-supporting tips 41 as centrally as possible into the previously aligned cables 19.

During the pressing-in, the spacer pins 9 form the indentations 33 in the matrix material 17 of the belt 3. For such purpose, the press-in tool 35 can be designed such that it remains on the belt 3 as a tool to be used once. In this case, the spacer pins 9 remain in the indentations 33 and can thus seal them. Alternatively, the press-in tool 35 can be removed again after the connecting element 5 has been correctly attached to the belt 3. In such case, the indentations 33 remain in the matrix material 17 of the belt 3. The indentations 33 can optionally be sealed with a layer 37 covering them. The covering layer 37 can be a plastic layer and applied such that it completely covers the indentations, thus sealing them in a fluid-tight manner.

Finally, it must be noted that terms such as “having,” “comprising,” etc. do not exclude any other elements or steps, and terms such as “an” or “a” do not exclude a multiplicity. It must further be noted that features or steps, which have been described with reference to one of the above embodiments, can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SIGNS

1 Belt arrangement
3 Belt
5 Connecting element
6 Main part of the connecting element
7 Contact pins (7′, 7″)
9 Spacer pins
10 Longitudinal extension direction
11 Arrangement direction
13 Frame
15 Electrical line
17 Matrix material
19 Cables
21 Profiled side
23 Flat side
25 Grooves
27 Ridges
29 Connection to the electrical line
31 Short-circuit connection between cables
33 Indentations
35 Press-in tool
37 Sealing layer
39 Press-in direction
41 Tips of the contact pins
43 Tips of the spacer pins
D Lateral distance between cables
d Width of spacer pins

1-14. (canceled)

15. A method for establishing an electrical connection between a connecting element and a load-bearing belt for an elevator system, wherein the connecting element has a plurality of electrically conductive contact pins arranged at a distance from one another in an arrangement direction and at least one of the contact pins is electrically connected to an electric line extending from the connecting element, wherein the belt has a plurality of electrically conductive cables embedded in an electrically insulating matrix material and arranged at a distance from one another in the arrangement direction, the method comprising the following steps:
pressing spacer pins between adjacent ones of the cables in the belt to move the cables to target positions in the belt for contacting by the contact pins; and
pressing the contact pins of the connecting element into the cables in the belt to electrically contact the cables.

16. The method according to claim 15 wherein the spacer pins are pressed in between the cables before the contact pins are pressed into the cables.

17. The method according to claim 15 wherein each of the spacer pins has a tip at a self-supporting end, the tip having a greater radius of curvature than tips at self-supporting ends of the contact pins.

18. The method according to claim 15 wherein each of the spacer pins has a tip at a self-supporting end, the tip having a radius of curvature that is between 0.3 and 3 times greater than a width of the spacer pin.

19. The method according to claim 15 wherein each of the spacer pins has a width equal to or smaller than the distance between adjacent ones of the cables in the belt.

20. The method according to claim 15 wherein the spacer pins are formed of or coated with an electrically insulating material.

21. The method according to claim 20 wherein the electrically insulating material is a plastic or a ceramic.

22. The method according to claim 15 wherein the spacer pins are formed as part of the connecting element.

23. The method according to claim 15 wherein the spacer pins are part of a press-in tool.

24. A belt arrangement for an elevator system with a load-bearing belt and a connecting element contacting the belt comprising:
the connecting element having a plurality of electrically conductive contact pins arranged at a distance from one another in an arrangement direction, and at least one of the contact pins is electrically connected to an electric line extending from the connecting element;
the belt having a plurality of electrically conductive cables embedded in an electrically insulating matrix material and arranged at a distance from one another in the arrangement direction;
wherein when the connecting element is pressed against a side of the belt, the contact pins are pressed into electrical contact with the cables; and
wherein the side of the belt has indentations pressed into the matrix material, each of the indentations being formed between adjacent ones of the cables.

25. The belt arrangement according to claim 24 wherein each of the spacer pins is pressed into an associated one of the indentations.

26. The belt arrangement according to claim 24 wherein the matrix material in an area of the indentations is sealed with a layer of material covering the indentations.

27. A connecting element for electrically contacting cables within a belt for an elevator system comprising: a frame having a plurality of electrically conductive contact pins protruding therefrom and being arranged at a distance from one another in an arrangement direction; and a plurality of electrically insulating spacer pins protruding from the frame, each of the spacer pins being arranged in the arrangement direction between adjacent ones of the contact pins.
